(19) United States
(12) Patent Application Publication
(10) Pub. No.: US 2007/0214084 A1
(43) Pub. Date: Sep. 13, 2007

(54) Credit hour financing method including a credit hour card

(76) Inventor: Linda Christine Boronico, Middlebury, CT (US)

Correspondence Address: DALE FRYE, 5421 S. PICCADILLY Cr., WEST BLOOMFIELD, MI, 48322, US

(21) Appl. No.: 11/370,736

(22) Filed: Mar. 9, 2006

(51) Int. Cl. G06Q 40/00

(52) U.S. Cl. 705/41

(57) ABSTRACT

A credit hour financing method which involves providing a financial instrument which has a value equal to and redeemable only for fractional, single or multiple credit hours at an institution of higher learning and redeeming said financial instrument for credit hours at said institution of higher learning.

### FIELD OF THE INVENTION

The present invention relates generally to financing tuition at institutions of higher learning, and more specifically to a method for financing such tuition by the purchase of credit hour cards equivalent to and redeemable only for credit hour tuition at an institution of higher learning.

### BACKGROUND OF THE INVENTION

Average college tuition costs for the 2005-06 school for a four-year private university average about $21,235 (up 5.9 percent from last year). For a four-year public university the tuition cost averages about $5,491 (up 7.1 percent from last year), and for a two-year public college the average full time tuition cost is about $2,191 (up 5.4 percent from last year). It is no wonder that about 44 percent of all students attend two-year colleges. Also, the average surcharge for out-of-state or out-of-district students at public institutions is $4,160 at two-year colleges and $7,673 at four-year colleges.

At these costs it is difficult for some students to afford the associated tuition costs for the school of their choice. Often families cannot afford to send their children to college, even to a local two year university. Many times extended families help by providing monetary support to the student in the form of a gift of monies. The student is not always inclined to use the monies specifically toward their higher learning expenses but rather on the day to day needs of the individual. This does not put them any closer to obtaining the goals of higher education. Often times tuition costs are too expensive and require too much financial commitment for a typical extended family member. It would be useful to provide for the extended family members a cost module that would represent a means by which they can support student's tuition costs. By purchasing fractional, single or multiple credit hours for the student rather than giving the student cash. This will help insure the financial support is used specifically for the purpose to which it was intended. It will also help provide direction for the student to bring there goals through final fruition because the gift can not be used for any other purpose. To that end it would be desirable to be able to purchase college credits conveniently at local retail outlets in the form of a credit hour gift card or some similar instrument which could then be gifted to the student whenever desired.

The present invention fills such a need by providing a method for financing college credit hour tuition.

### SUMMARY OF THE INVENTION

The present invention is a credit hour financing method which includes the steps of providing a financial instrument which has a value equal to and redeemable only for fractional, single or multiple credit hours at an institution of higher learning; and redeeming the financial instrument for credit hours at the institution of higher learning. The financial instrument may be a gift card. The financial instrument may include markings or indicia identifying the instrument and/or the institution of higher learning. The markings or indicia identifying the instrument may be recorded into a database.

The financial instrument may be sold at a retail outlet which may be the institution of higher learning or alternatively may be businesses such as pharmacies, convenience stores, department stores, bookstores, web sites, and web stores. The retail outlet may transmit data concerning the financial instrument to a record keeping entity, which may be the institution of higher learning. The record keeping entity may record the data concerning the financial instrument into said database.

Once the financial instrument is used, information of the use may be transmitted from the institution of higher learning to the record keeping entity. The record keeping entity then may deactivate the financial instrument in the database. The record keeping entity may track any financial instruments which expire unused and may deactivating the expired financial instruments in the database.

The proceeds of the sale of the financial instrument at the retail outlet may be transferred to a trust, which may be managed by a trust management entity. The trust management entity may be the institution of higher learning. Once the financial instrument is used, funds from the trust may be transferred to the institution of higher learning to cover the credits purchased.

### DETAILED DESCRIPTION OF THE INVENTION

The present invention is a method and system of financing college tuition. The heart of the method includes providing a financial instrument having a value equal to and redeemable only for fractional, single or multiple credit hours at an institution of higher learning such as a university, college, technical vocational school, or any other institution of learning past grade school, in which education is paid for in credit hours. The useful fraction or multiple of a credit hour that the financial instrument may be valued at would depend on the actual cost of a credit hour at the particular institution of higher learning. For example, if the cost of a credit hour at the desired institution of higher learning in high (e.g. $500), the financial instrument may be issued in fractional increments such as, for example, one half, one quarter, or one eighth of a credit hour. Alternatively, if the if the cost of a credit hour at the desired institution of higher learning in low (e.g. $50), the financial instrument may be issued for a single or multiple credit hours.

Once provided, the financial instrument may be redeemed only for the specified credit hours at the specified institution of higher learning. The financial instruments may preferably having markings or indicia identifying the instrument for recordation into a database. Markings or indicia may include serial numbers, bar codes, electronically encoded data, or other recognizable markings or features. Further the financial instrument may be individualized for different institutions of higher learning by incorporation of visual identifiers such as school colors, logo, insignia, mascot, etc. Alternatively the financial instruments may be visually generic and information regarding the institution of higher learning and value of the card may be encoded onto the financial instrument or into a database.

The financial instruments may be sold by a retail outlet. The retail outlet may be the institution of higher learning itself or some other retail outlet. Other retail outlets may include pharmacies, convenience stores, department stores, bookstores, internet web-sites and web-stores etc. The retail outlet that sells the financial instrument may activate the instrument or the retail outlet may transmit data concerning the financial instrument to a record keeping entity which may be the institution of higher learning or a separate entity.

Anyone may purchase the financial instrument and once purchased it may be used the same as any other form of currency with the restriction that it may only be used to purchase course credit hours at the institution of higher learning. The present inventor envisions that the financial instrument would take the form of a credit hour card and be purchased by individuals interested in giving the card to another person, such as a friend or relative. Alternatively the card may be purchased by the student for personal use. The value of the credit hour card would remain equal to the number of credits purchased even if not used within a specified period of time. However, the credit hour cards may be designed to expire after a specified period of time so that the present cost of credit hours does not greatly exceed the original purchase price of the credit hour card.

The record keeping facility may record the indicia of the financial instrument and its credit value for future reference such as when the financial instrument is used to purchase credit hours at the institution of higher learning. Once the financial instrument is used to purchase credit hours, the institution of higher learning would transmit that information to the record keeping entity which would then deactivate the financial instrument in its database. The record keeping facility would also keep track of any financial instruments which expire unused and deactivate the expired financial instruments in the database.

Finally, the money from the sale of the financial instruments would be sent by the retailers to a trust which would be managed by a trust management entity. Once a financial instrument is used to purchase credits, the trust management entity would transfer the proper amount of funds from the trust to the institution of higher learning to cover the credits purchased. The trust management entity may be the institution of higher learning, or the same entity as the record keeping facility or may be a separate entity altogether.

I claim:

1. A credit hour financing method comprising:
providing a financial instrument which has a value equal to and redeemable only for fractional, single or multiple credit hours at an institution of higher learning; and
redeeming said financial instrument for credit hours at said institution of higher learning.

2. The method of claim 1, wherein said financial instrument is a gift card.

3. The credit hour financing method of claim 1, wherein said financial instrument includes markings or indicia identifying said instrument.

4. The credit hour financing method of claim 3, wherein said financial instrument further includes markings or indicia identifying said institution of higher learning.

5. The credit hour financing method of claim 3, including the further step of recording said markings or indicia identifying said instrument into a database.

6. The credit hour financing method of claim 5, including the further step of selling said financial instrument at a retail outlet.

7. The method of claim 6, wherein said retail outlet is said institution of higher learning.

8. The method of claim 6, wherein said retail outlet includes pharmacies, convenience stores, department stores, bookstores, web sites, and web stores.

9. The credit hour financing method of claim 6, including the further step transmitting data concerning said financial instrument from said retail outlet to a record keeping entity.

10. The method of claim 9, wherein said record keeping entity is said institution of higher learning.

11. The credit hour financing method of claim 9, including the further step recording said data concerning said financial instrument into said database.

12. The method of claim 11, further including the steps of:
transmitting information from said institution of higher learning to said record keeping entity upon use of said financial instrument; and
said record keeping entity deactivating said financial instrument in said database.

13. The method of claim 11, further including the steps of:
said record keeping entity tracking any financial instruments which expire unused; and
deactivating the expired financial instruments in said database.

14. The credit hour financing method of claim 6, including the further step of transferring the proceeds of the sale of said financial instrument at said retail outlet to a trust.

15. The method of claim 14, wherein said trust is managed by a trust management entity.

16. The method of claim 15, wherein said trust management entity is said institution of higher learning.

17. The method of claim 14, including the further step of:
transmitting funds from said trust to said institution of higher learning to cover the credits purchased upon use of said financial instrument.
